(19) United States
(12) Patent Application Publication
(10) Pub. No.: US 2018/0365688 A1
(43) Pub. Date: Dec. 20, 2018

(54) TRANSACTION EXECUTION AND VALIDATION IN A BLOCKCHAIN

(71) Applicant: International Business Machines Corporation, Armonk, NY (US)

(72) Inventors: Miao He, Beijing (CN); Changrui Ren, Beijing (CN); Bing Shao, Beijing (CN); Yue Tong, Beijing (CN)

(21) Appl. No.: 15/622,844

(22) Filed: Jun. 14, 2017

(51) Int. Cl. G06Q 20/38; G06Q 20/40

(52) U.S. Cl. CPC G06Q 20/3829; G06Q 20/401

(57) ABSTRACT

A blockchain of transactions may be referenced for various purposes and may be later accessed by interested parties for ledger verification and information retrieval. One example may include one or more of identifying a potential transaction during a transaction commitment procedure, retrieving committed transactions associated with an account, determining a priority associated with the potential transaction, determining a priority of data associated with the committed transactions, comparing the priority associated with the potential transaction with the priority of data associated with the committed transactions, and determining whether to commit the potential transaction in a blockchain or reject the potential transaction.

### TECHNICAL FIELD

This application generally relates to managing transaction commitment, and more particularly, to transaction execution and validation in a blockchain.

### BACKGROUND

A blockchain may be used as a public ledger to store any type of information. Although, primarily used for financial transactions, a blockchain can store any type of information including assets (i.e., products, packages, services, status, etc.). A blockchain may be used to securely store any type of information in its immutable ledger. Decentralized consensus is different from the traditional centralized consensus, such as when one central database used to rule transaction validity. A decentralized scheme transfers authority and trusts to a decentralized network and enables its nodes to continuously and sequentially record their transactions on a public “block,” creating a unique “chain” referred to as a blockchain. Cryptography, via hash codes, is used to secure the authentication of the transaction source and removes the need for a central intermediary.

Except for the real-time transactions supported by most of the smart contracts on different instances of blockchain, committed transactions are increasingly used in the financial industry. Examples of committed transactions which are likely to become increasingly popular may include the settlement of debts, settlement of guarantees, installment loans/payments, loans, interpersonal lending, etc. ‘Net D’ is one of the commonly used conventions in the international trade community, for example, the notation “net 30” indicates that full payment is expected within 30 days. Any commonly used or widely accepted convention for financial service management may need to be adapted to a blockchain infrastructure.

### SUMMARY

One example method of operation may include one or more of identifying a potential transaction during a transaction commitment procedure, retrieving committed transactions associated with an account, determining a priority associated with the potential transaction, determining a priority of data associated with the committed transactions, comparing the priority associated with the potential transaction with the priority of data associated with the committed transactions, and determining whether to commit the potential transaction in a blockchain or reject the potential transaction.

Another example embodiment may include an apparatus that includes a processor configured to perform one or more of identify a potential transaction during a transaction commitment procedure, retrieve committed transactions associated with an account, determine a priority associated with the potential transaction, determine a priority of data associated with the committed transactions, compare the priority associated with the potential transaction with the priority of data associated with the committed transactions, and determine whether to commit the potential transaction in a blockchain or reject the potential transaction.

Still another example embodiment may include a non-transitory computer readable storage medium configured to store instructions that when executed cause a processor to perform one or more of identifying a potential transaction during a transaction commitment procedure, retrieving committed transactions associated with an account, determining a priority associated with the potential transaction, determining a priority of data associated with the committed transactions, comparing the priority associated with the potential transaction with the priority of data associated with the committed transactions, and determining whether to commit the potential transaction in a blockchain or reject the potential transaction.

### BRIEF DESCRIPTION OF THE DRAWINGS

FIG. 1A illustrates a non-miner peer node configuration according to example embodiments.

FIG. 1B illustrates a miner peer node configuration according to example embodiments.

FIG. 1C illustrates a tree configuration for account management according to example embodiments.

FIG. 2A illustrates a logic flow diagram of a payment processing configuration according to example embodiments.

FIG. 2B illustrates a logic flow diagram of a transaction verification and validation configuration according to example embodiments.

FIG. 3 illustrates a system signaling diagram of the interactions between new transactions, known transactions and a blockchain according to example embodiments.

FIG. 4A illustrates a flow diagram of an example method of managing transaction validation in the blockchain according to example embodiments.

FIG. 4B illustrates another flow diagram of an example method of managing transaction validation in the blockchain according to example embodiments.

FIG. 5 illustrates an example network entity configured to support one or more of the example embodiments.

### DETAILED DESCRIPTION

It will be readily understood that the instant components, as generally described and illustrated in the figures herein, may be arranged and designed in a wide variety of different configurations. Thus, the following detailed description of the embodiments of at least one of a method, apparatus, non-transitory computer readable medium and system, as represented in the attached figures, is not intended to limit the scope of the application as claimed, but is merely representative of selected embodiments.

The instant features, structures, or characteristics as described throughout this specification may be combined in any suitable manner in one or more embodiments. For example, the usage of the phrases “example embodiments”, “some embodiments”, or other similar language, throughout this specification refers to the fact that a particular feature, structure, or characteristic described in connection with the embodiment may be included in at least one embodiment. Thus, appearances of the phrases “example embodiments”, “in some embodiments”, “in other embodiments”, or other similar language, throughout this specification do not necessarily all refer to the same group of embodiments, and the described features, structures, or characteristics may be combined in any suitable manner in one or more embodiments.

In addition, while the term “message” may have been used in the description of embodiments, the application may be applied to many types of network data, such as, packet, frame, datagram, etc. The term “message” also includes packet, frame, datagram, and any equivalents thereof. Furthermore, while certain types of messages and signaling may be depicted in exemplary embodiments they are not limited to a certain type of message, and the application is not limited to a certain type of signaling.

The instant application in one embodiment relates to managing transaction commitment in a trust ledger, and in another embodiment relates to identifying new transactions and comparing the transactions to known transaction data to determine whether to commit the new transactions.

Example embodiments provide user account information being stored, organized, and accessed in a blockchain. Also, the account may be stopped or ‘frozen’ via an account update process which may include a new transaction which is attempting to be committed to the blockchain and which is not valid. In the event that the transaction is validated properly, the transaction may be committed to the blockchain and reflected in the user account information. In general, committed transactions are legal when there are signatures, or stamps on the contracts which enable the laws to be upheld. The blockchain permits an offline signing and stamping process to digital contracts including digital signatures which provide the necessary evidence to uphold certain contracts. In the event that there is a questionable or invalid account, the account may be frozen because one can authorize a transaction from his/her account. In one example, a user A may need to pay another user B $100. Today, user A has $200 coming into their account, but the money was transferred out immediately without executing the planned payment of $100 to user B. In this scenario, the second transfer will not be processed by the blockchain system since the $100 in user A's account is frozen for user B. In order to freeze one's account efficiently, especially when there are multiple types of committed transactions with different expiration times or other conditions, may provide certain later committed transactions which have an earlier planned payment date regardless of a current user account balance.

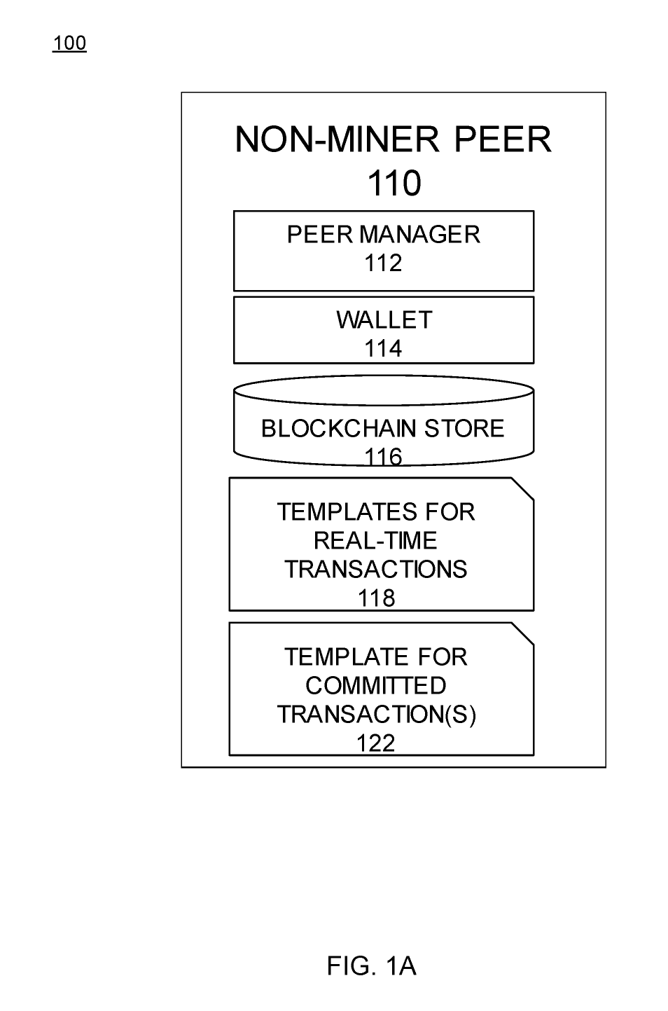

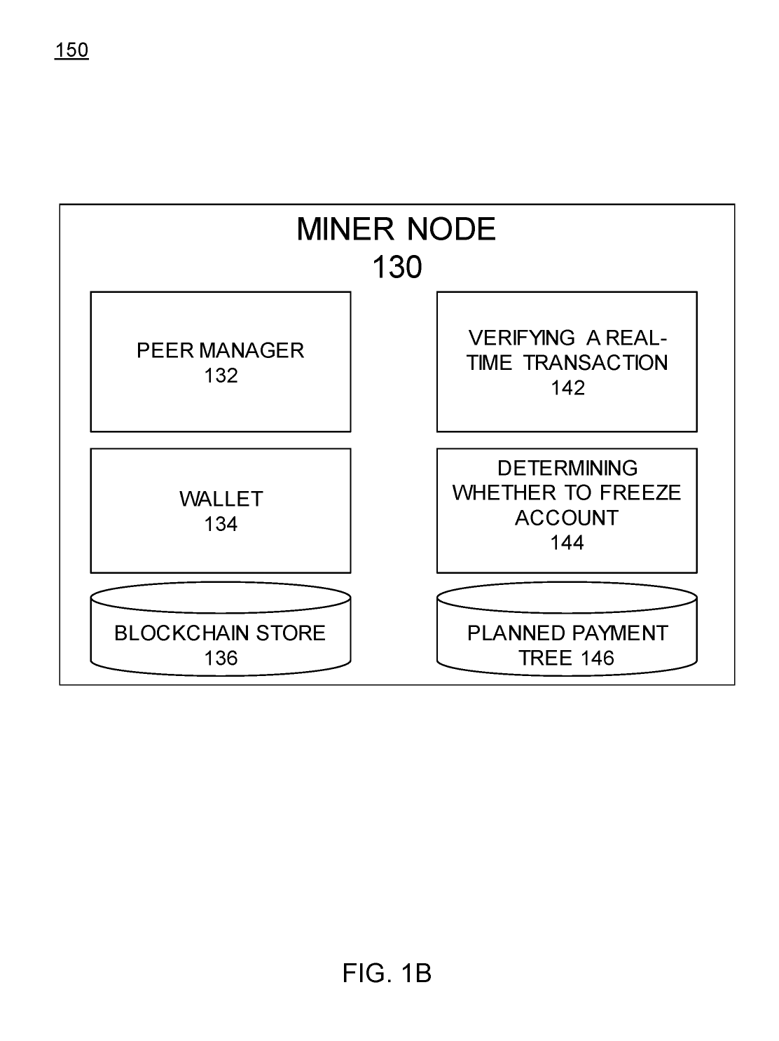

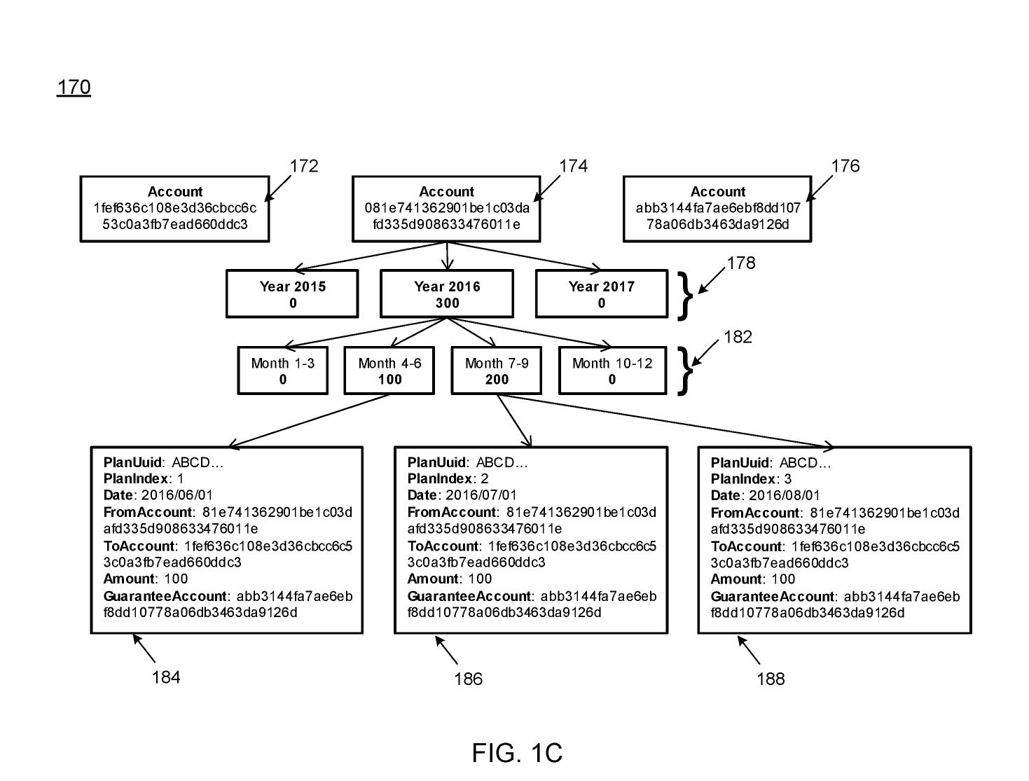

FIG. 1A illustrates a non-miner peer node configuration according to example embodiments. Referring to FIG. 1A, the example 100 includes a non-miner node participating on a blockchain 110, which would have a peer manager module 112, a wallet module 114, a blockchain store of transaction data 116, and templates for real-time transactions 118 and committed transactions 122. The majority of committed blockchain transactions, in general, are not subject to specific templates, however, the template must be adhered to in order to organize and access data, especially when attempting to balance a user account balance and identify transaction priorities and other needed transaction information.

FIG. 1B illustrates a miner peer node configuration according to example embodiments. Referring to FIG. 1B, the miner node configuration 150 includes an example miner node 130 with various modules, such as a peer manager 132, a wallet 134, a blockchain storage 136 of blockchain data, a real-time transaction verification module 142. In addition, the decision as to whether to freeze an account 144 and whether to plan a future payment ahead of time 146 requires logic which examines blockchain data and determines whether availability can be identified for later scheduled payments and/or decisions to freeze an account pending a particular outcome. The account may be frozen for payments which are not recognized and do not have any history, for example, payments which are not mortgages and car payments or other common and popular payments may be suspect for dismissal and causing an account freeze, etc.

FIG. 1C illustrates a tree configuration for account management according to example embodiments. In FIG. 1C, the basic template for committed transactions may include information such as a date, “from” account number, “to” account number, amount, and a guarantee account number. All the committed transactions associated with an account must be considered in the validation process. In this configuration, the data stored in the blockchain are not only transactions but also planned payments (i.e. future payments). In the event that a transaction is an execution of a planned payment then it must refer to the planned payment identifier, which is stored in the transaction data of the blockchain. The transaction template that is used includes a payment date, a payment amount and a digital signature. The priority tree configuration enables quick verification for freezing an account. The cache maintains a key value database of unspent transaction outputs (UTXOs) and a tree structure of planned payments. In the configuration 170, a tree structure is maintained for each account. In this example, there may be multiple accounts 172-176. In one particular account 174, for example, the tree maintains data which identifies the years 178 months 182 and may even identify other time frame granularities. In one embodiment, the data may include the settlement of debts, settlement of guarantees, installment loans/payments, loans, interpersonal lending, name, address, phone number, biometrics, date, time, type of device, currency, financial security, etc.

In a financial example, the total amount of payments/debts can be easily identified for each relative time frame. In this example, the first payment 184 is for a particular time frame while other payments 186 and 188 are identified for a different time period. The tree structure provides a way to calculate a total amount of debt before a particular point in time or amount of time (i.e., day). The nodes in the tree may not require referencing since they may be before the designated date and may be of no interest to the calculation procedure for the current payment plan process.

According to example embodiments, a new monetary transaction may be identified and a set queried priority of the transaction may be the lowest among all the expired but un-executed committed transactions. Using the date as an example, the priority may be set to be the current day (i.e., today). The tree configuration enables a quick retrieval of the amount that should be paid before today from the sum tree by a binary search operation. If the result is that account balance < the unpaid amount, then this current monetary transaction may be refused. If the account balance >= the unpaid amount then the monetary transaction may be accepted if other verification succeeds.

In another example, a new payment to a committed transaction is identified and the queried priority is set to be the priority that was specified in the committed transaction, which is referred to by the new payment transaction. The amount of planned payments which have higher priority over the requested payment may be the basis for the new payment transaction. Those payments are identified and if an unpaid amount with a higher priority > the account balance after the new payment, then this new monetary transaction may be refused. If the unpaid amount with a higher priority <= the account balance after the new payment then the monetary transaction may be accepted if other verification measures succeed. A tree structure storage of the planned payments may include the non-leaf nodes branching by payment priority where the planned payment date is one example of a priority metric. The sum of the amount at each non-leaf node may be stored. A quick verification process of a miner node could provide a verification logic that could “freeze” an account from performing the top prioritized transaction, which mimics the “freezing” behavior of the centralized financial system without knowing the private key of a malicious user. The verification logic may provide retrieving the queried priority, searching the amount of the unpaid amount which has higher priority over the requested transaction and refusing or accepting the current requested transaction.

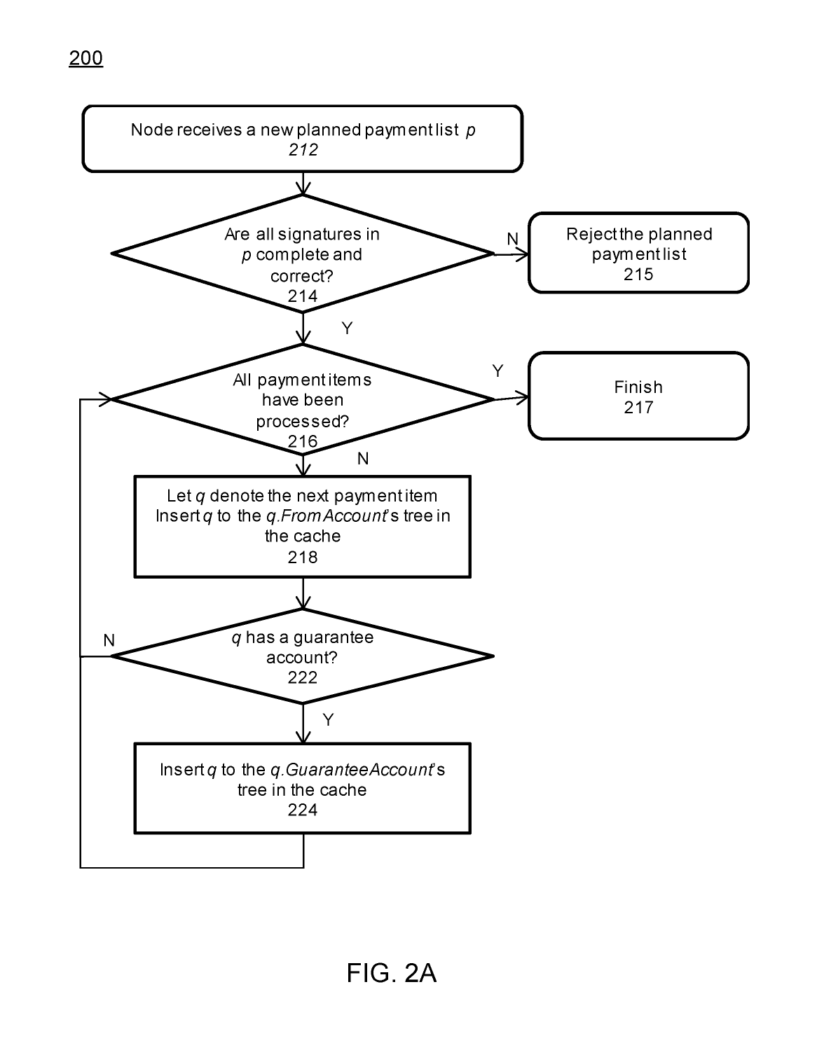

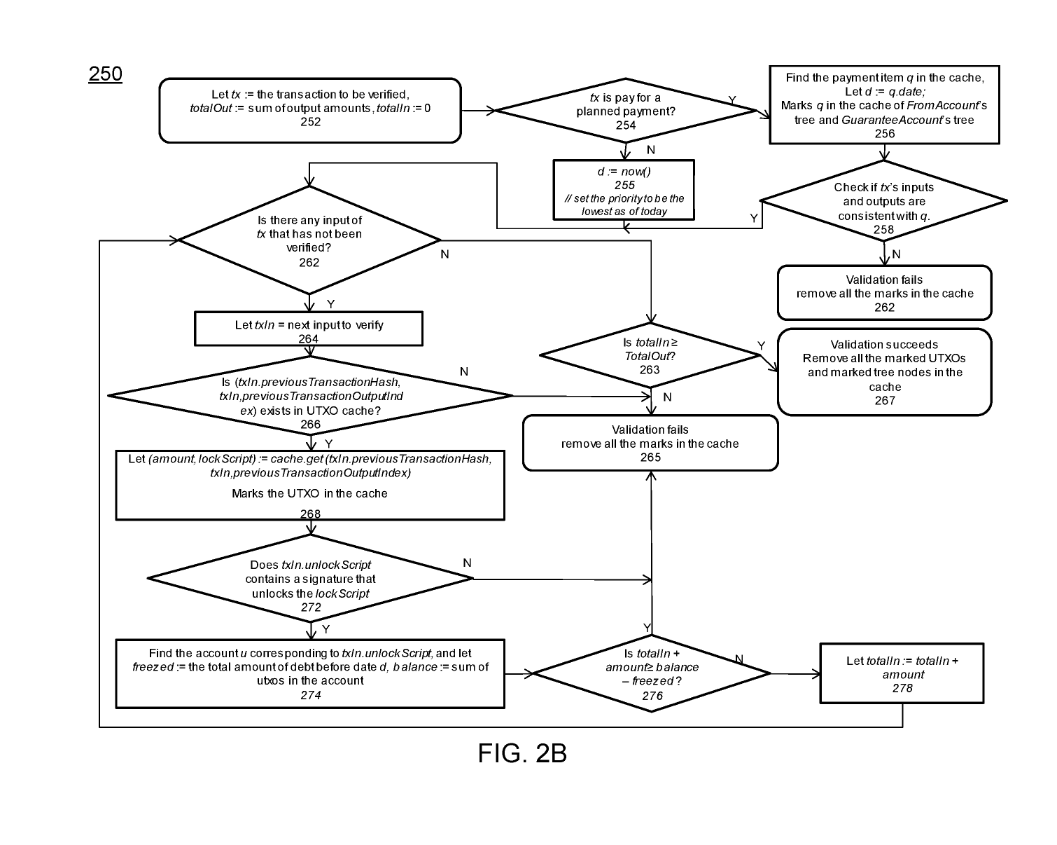

FIG. 2A illustrates a logic flow diagram 200 of a payment processing configuration according to example embodiments. Referring to FIG. 2A, the example includes a node receiving 212 a new planned payment list ‘p’. This flow is used to illustrate the processes included in maintaining the committed transaction priority tree. A first determination may include determining whether all signatures in the list are complete and correct per the requirements 214, if not the list is rejected 215. Also, another determination is used to determine whether all payments are processed 216. If so, then the process is completed 217 and if not, then the ‘q’ may be used to denote a next payment item and it may be inserted into the q.FromAccount's tree in the cache 218. Another determination is whether ‘q’ has a guarantee account 222 if so, then then it may be added to the q.GuaranteeAccount's tree in the cache 224, and the process is repeated for any additional transactions.

FIG. 2B illustrates a logic flow diagram of a transaction verification and validation configuration according to example embodiments. Referring to FIG. 2B, the example 250 includes various operations which may be used to determine whether to freeze a particular account. The process begins with transaction to be verified tx, and a totalOut value which is the sum of output amounts, and a value totalin is equal to zero 252. The determination is made as to whether the transaction (tx) is payment for a planned payment 254. If so, then the payment item ‘q’ may be identified in the cache and d may be set to q.date and q is marked in the cache of a from account tree and guarantee account tree 256. Next, a check is made 258 to determine if the transaction inputs and outputs are consistent with ‘q’. If not, the validation fails and all marks in the cache are removed 262. If tx is not paying for a planned payment, the is set to now( ) which sets the priority to be the lowest as of today 255. A determination is then made 262 to determine whether there are any input transactions not yet verified 262. If not, then the ‘totalin’ value is determined to be greater than or equal to the ‘totalout’ 263, and if so, the validations is deemed a success and all the marked UTXOs are removed along with the marked tree nodes in the cache 267. If the ‘totalin’ value is not greater than or equal to the ‘totalout’ value 263 then the validation fails and the marks are removed from the cache 265. If in 262, there are transactions which have not yet been verified, then the transaction value ‘txin’ is set to a next input to verify 264 and a determination is made as to whether the value ‘txin.previoustransactionhash’, ‘txin’ and ‘previoustransactionoutputindex’ exists in the UTXO cache 266, if not, the validation fails. If so, then the value ‘amount’ and ‘lockscript’ are set to the result of cache.get function with parameters ‘txin.previoustransactionhash’, ‘txin’ and ‘previoustransactionoutputindex’ which marks the UTXO in the cache 268. Another determination is performed as to whether the txin.unlockscript contains a signature that unlocks the lockscript 272. If so, the account ‘u’ is identified which corresponds to the txin.unlockscript and lets the total amount of debt before date be frozen, and the balance is set to a sum of UTXOs in the account 274. If not, then the determination is made as to whether the ‘totalin’+the amount is greater than or equal to balance−freezed portion 276. If so, the validation fails 265. If not, then the ‘totalin’ is set to ‘totalin’+amount 278.

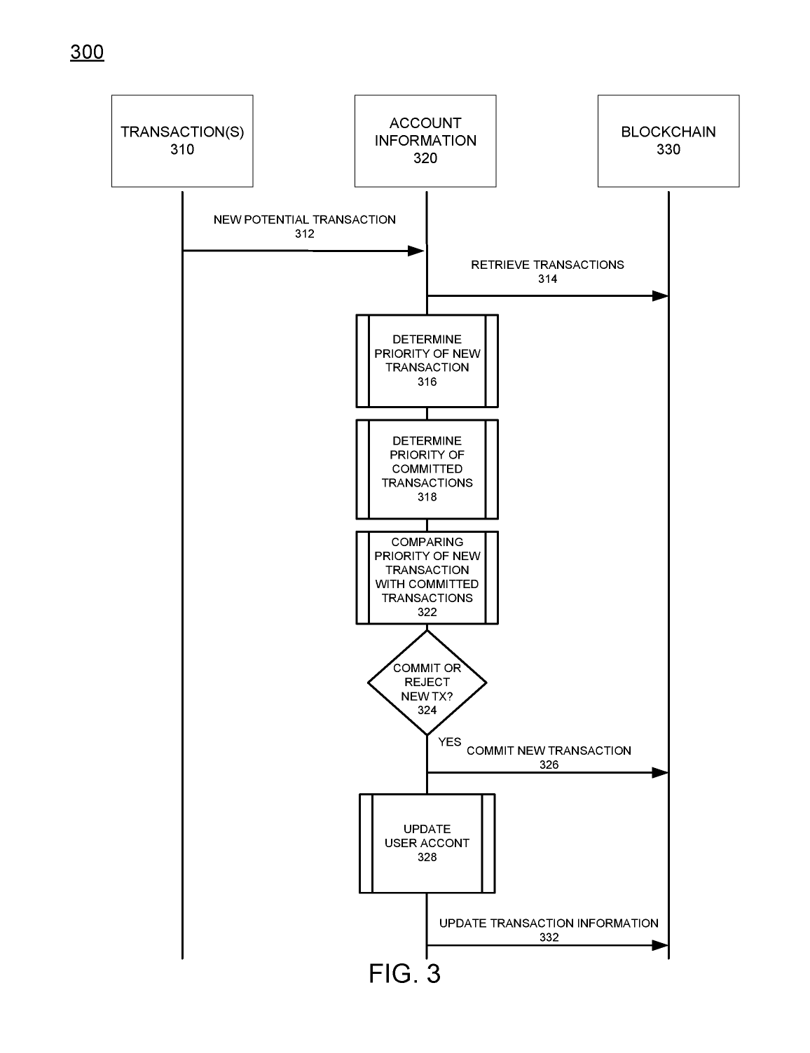

FIG. 3 illustrates a system messaging diagram of the interactions between new transactions 300, known transactions and a blockchain according to example embodiments. Referring to FIG. 3, the system 300 may include a number of components or modules which may include software, hardware or a combination of both. Referring to FIG. 3, the example system may provide communication between a first component, incoming transactions 310, a second component, account information of a consumer 320, and a third component, a blockchain 330. In operation, a new potential blockchain transaction 312 is identified for a particular account 320. The information about the account is retrieved 314 and a determination is made as to a priority of the new transaction 316. This may be based on the transaction content, an account identifier or any of the various parameters included in the transaction. The committed transactions are also identified according to their priority 318. The priorities are compared 322 to determine whether the new rejection should be rejected or committed 324. Other information used in this determination may be account balances and account history. Assuming a decision to commit the new transaction is made 326 the blockchain may be updated and the user account information 328 may also be updated to reflect the update 332 to the blockchain.

In one embodiment, the first component, the second component and the third component may be separate devices such as servers, computers or other computational devices or may be a single device. In other embodiments, the first component and the second component may be enclosed as, or perform as, a single device, the first component and the third component may be enclosed as, or perform as, a single device, and the second component and the third component may be enclosed as, or perform as, a single device. The components or devices 310, 320 and 330 may be directly connected or communicably coupled to one another, in a wired or wireless manner, and may reside locally and/or remotely.

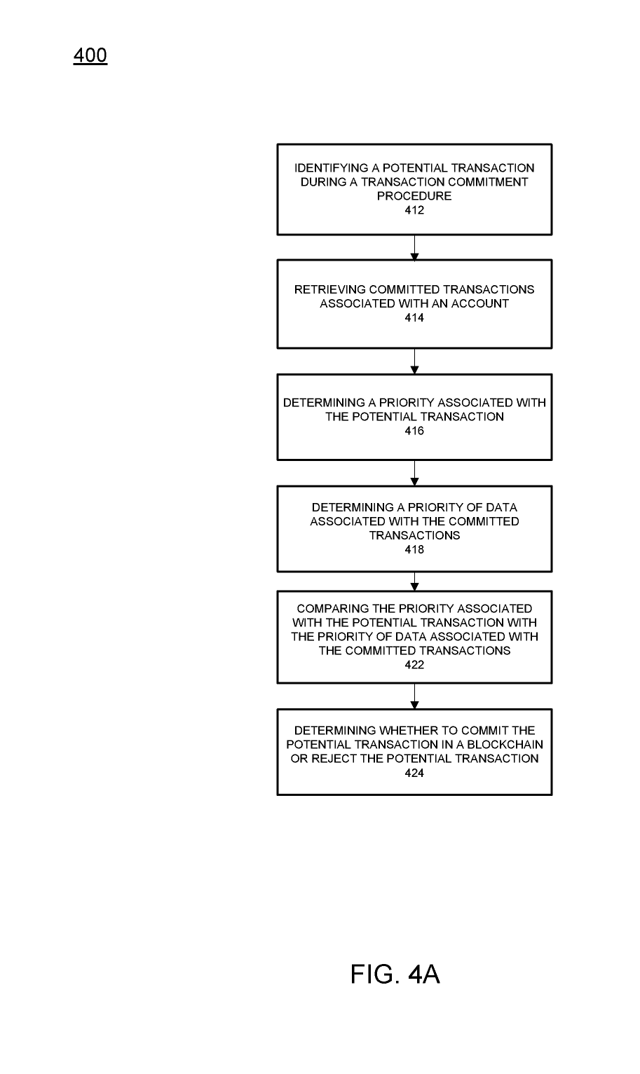

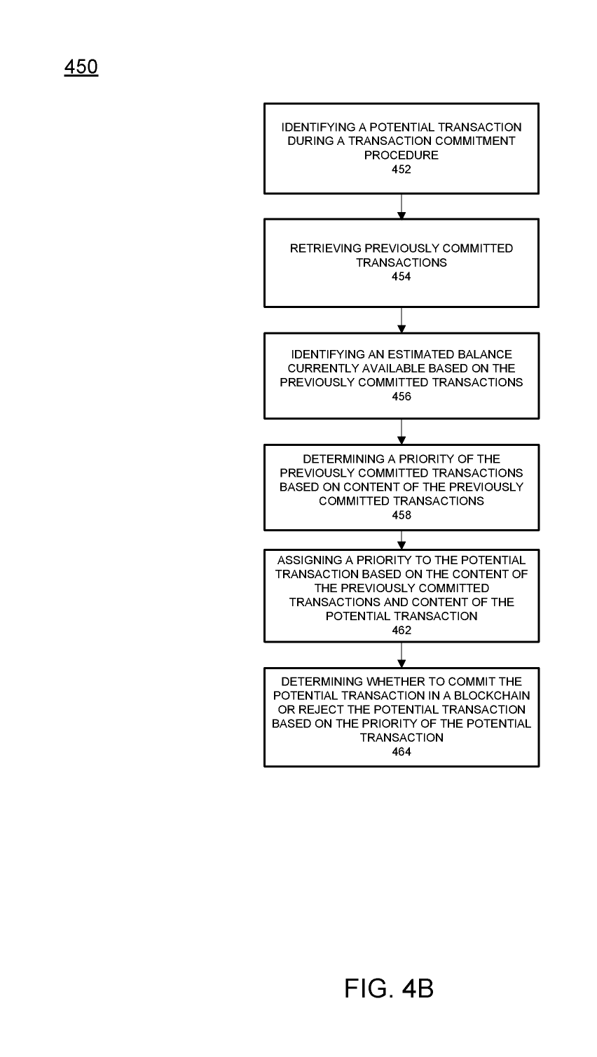

FIG. 4A illustrates a flow diagram of an example of managing transaction validation in the blockchain according to example embodiments. Referring to FIG. 4A, the method 400 may include identifying a potential transaction during a transaction commitment procedure 412, retrieving committed transactions associated with an account 414, determining a priority associated with the potential transaction 416, determining a priority of data associated with the committed transactions 418, comparing the priority associated with the potential transaction with the priority of data associated with the committed transactions 422, and determining whether to commit the potential transaction in a blockchain or reject the potential transaction 424.

The method may further include determining an amount associated with the potential transaction, and determining the data associated with the committed transactions. The method may also include identifying a script associated with the potential transaction, wherein the script comprises one or more of a planned payment amount, a planned payment date, an origination account, a destination account, payment conditions, and a private key verified by contracting parties to the potential transaction, identifying the data as one or more planned payments, identifying priorities and debt amounts of the planned payments, comparing the priority and debt amount associated with the potential transaction to the priorities and debt amounts of the planned payments, and responsive to the comparing, determining whether to commit the potential transaction in the blockchain or reject the potential transaction. The method may further provide retrieving a priority tree data structure from the blockchain, and identifying the planned payments from the priority tree structure. The priority associated with the potential transaction may include a date that is used to identify the priority among other attributes. The method may also include identifying a planned payment list associated with the data, verifying signatures on all planned payments in the planned payment list, identifying one or more unprocessed planned payments, and verifying a guarantee account is linked to the unprocessed planned payments.

FIG. 4B illustrates another flow diagram of an example of managing transaction validation in the blockchain according to example embodiments. The method 450 may include identifying a potential transaction during a transaction commitment procedure 452, identifying previously committed transactions 454, identifying an estimated balance currently available based on the previously committed transactions 456, determining a priority of the previously committed transactions based on content associated with the previously committed transactions 458, and assigning a priority to the potential transaction based on content of the previously committed transactions and content of the potential transaction 462, and determining whether to commit the potential transaction in a blockchain or reject the potential transaction based on the priority of the potential transaction 464.

As transactions are committed, the content of those transactions is stored in the blockchain and may be retrieved to identify spending habits of a consumer. The pending transaction may be kept pending until a priority can be assigned to the previous transactions and the current pending transaction. For example, if the previous transactions demonstrate a consumer has readily paid their car payment and mortgage payments but is otherwise delinquent on various other payments, then the content of the potential transaction may be identified and compared to the committed transactions to identify a currently assigned priority of the potential transaction which can then be used to determine whether the consumer is likely to pay their debts including the present potential transaction.

The above embodiments may be implemented in hardware, in a computer program executed by a processor, in firmware, or in a combination of the above. A computer program may be embodied on a computer readable medium, such as a storage medium. For example, a computer program may reside in random access memory (“RAM”), flash memory, read-only memory (“ROM”), erasable programmable read-only memory (“EPROM”), electrically erasable programmable read-only memory (“EEPROM”), registers, hard disk, a removable disk, a compact disk read-only memory (“CD-ROM”), or any other form of storage medium known in the art.

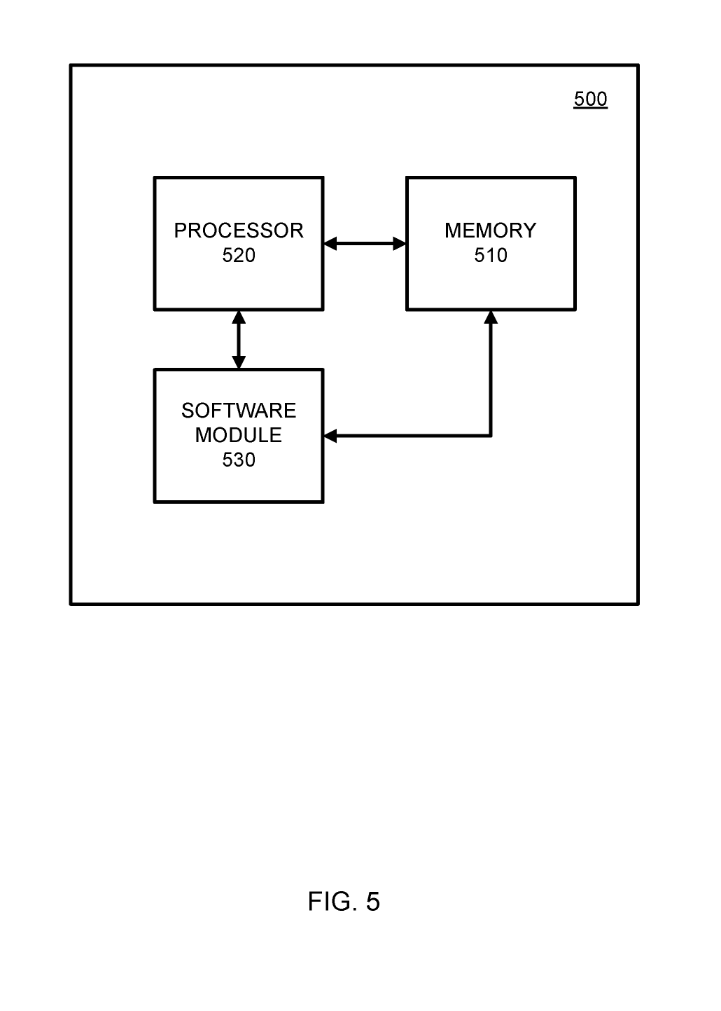

An exemplary storage medium may be coupled to the processor such that the processor may read information from, and write information to, the storage medium. In the alternative, the storage medium may be integral to the processor. The processor and the storage medium may reside in an application specific integrated circuit (“ASIC”). In the alternative, the processor and the storage medium may reside as discrete components. For example, FIG. 5 illustrates an example network element 500, which may represent or be integrated in any of the above-described components, etc.

As illustrated in FIG. 5, a memory 510 and a processor 520 may be discrete components of a network entity 500 that are used to execute an application or set of operations as described herein. The application may be coded in software in a computer language understood by the processor 520, and stored in a computer readable medium, such as, a memory 510. The computer readable medium may be a non-transitory computer readable medium that includes tangible hardware components, such as memory, that can store software. Furthermore, a software module 530 may be another discrete entity that is part of the network entity 500, and which contains software instructions that may be executed by the processor 520 to effectuate one or more of the functions described herein. In addition to the above noted components of the network entity 500, the network entity 500 may also have a transmitter and receiver pair configured to receive and transmit communication signals (not shown).

Although an exemplary embodiment of at least one of a system, method, and non-transitory computer readable medium has been illustrated in the accompanied drawings and described in the foregoing detailed description, it will be understood that the application is not limited to the embodiments disclosed, but is capable of numerous rearrangements, modifications, and substitutions as set forth and defined by the following claims. For example, the capabilities of the system of the various figures can be performed by one or more of the modules or components described herein or in a distributed architecture and may include a transmitter, receiver or pair of both. For example, all or part of the functionality performed by the individual modules, may be performed by one or more of these modules. Further, the functionality described herein may be performed at various times and in relation to various events, internal or external to the modules or components. Also, the information sent between various modules can be sent between the modules via at least one of: a data network, the Internet, a voice network, an Internet Protocol network, a wireless device, a wired device and/or via plurality of protocols. Also, the messages sent or received by any of the modules may be sent or received directly and/or via one or more of the other modules.

One skilled in the art will appreciate that a “system” could be embodied as a personal computer, a server, a console, a personal digital assistant (PDA), a cell phone, a tablet computing device, a smartphone or any other suitable computing device, or combination of devices. Presenting the above-described functions as being performed by a “system” is not intended to limit the scope of the present application in any way, but is intended to provide one example of many embodiments. Indeed, methods, systems and apparatuses disclosed herein may be implemented in localized and distributed forms consistent with computing technology.

It should be noted that some of the system features described in this specification have been presented as modules, in order to more particularly emphasize their implementation independence. For example, a module may be implemented as a hardware circuit comprising custom very large scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, or the like.

A module may also be at least partially implemented in software for execution by various types of processors. An identified unit of executable code may, for instance, comprise one or more physical or logical blocks of computer instructions that may, for instance, be organized as an object, procedure, or function. Nevertheless, the executables of an identified module need not be physically located together, but may comprise disparate instructions stored in different locations which, when joined logically together, comprise the module and achieve the stated purpose for the module. Further, modules may be stored on a computer-readable medium, which may be, for instance, a hard disk drive, flash device, random access memory (RAM), tape, or any other such medium used to store data.

Indeed, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

It will be readily understood that the components of the application, as generally described and illustrated in the figures herein, may be arranged and designed in a wide variety of different configurations. Thus, the detailed description of the embodiments is not intended to limit the scope of the application as claimed, but is merely representative of selected embodiments of the application.

One having ordinary skill in the art will readily understand that the above may be practiced with steps in a different order, and/or with hardware elements in configurations that are different than those which are disclosed. Therefore, although the application has been described based upon these preferred embodiments, it would be apparent to those of skill in the art that certain modifications, variations, and alternative constructions would be apparent.

While preferred embodiments of the present application have been described, it is to be understood that the embodiments described are illustrative only and the scope of the application is to be defined solely by the appended claims when considered with a full range of equivalents and modifications (e.g., protocols, hardware devices, software platforms etc.) thereto.

What is claimed is:

1. A method, comprising:
identifying a potential transaction during a transaction commitment procedure;
retrieving committed transactions associated with an account;
determining a priority associated with the potential transaction;
determining a priority of data associated with the committed transactions;
comparing the priority associated with the potential transaction with the priority of data associated with the committed transactions; and
determining whether to commit the potential transaction in a blockchain or reject the potential transaction.

2. The method of claim 1, further comprising:
determining an amount associated with the potential transaction; and
determining the data associated with the committed transactions.

3. The method of claim 1, further comprising:
identifying a script associated with the potential transaction, wherein the script comprises one or more of a planned payment amount, a planned payment date, an origination account, a destination account, payment conditions, and a private key verified by contracting parties to the potential transaction.

4. The method of claim 1, further comprising:
identifying the data as one or more planned payments;
identifying priorities and debt amounts of the planned payments;
comparing the priority and debt amount associated with the potential transaction to the priorities and debt amounts of the planned payments; and
responsive to the comparing, determining whether to commit the potential transaction in the blockchain or reject the potential transaction.

5. The method of claim 4, further comprising:
retrieving a priority tree data structure from the blockchain; and
identifying the planned payments from the priority tree structure.

6. The method of claim 1, wherein the priority associated with the potential transaction comprises a date.

7. The method of claim 1, further comprising:
identifying a planned payment list associated with the data;
verifying signatures on all planned payments in the planned payment list;
identifying one or more unprocessed planned payments; and
verifying a guarantee account is linked to the unprocessed planned payments.

8. An apparatus, comprising:
a processor configured to:
identify a potential transaction during a transaction commitment procedure;
retrieve committed transactions associated with an account;
determine a priority associated with the potential transaction;
determine a priority of data associated with the committed transactions;
compare the priority associated with the potential transaction with the priority of data associated with the committed transactions; and
determine whether to commit the potential transaction in a blockchain or reject the potential transaction.

9. The apparatus of claim 8, wherein the processor is further configured to:
determine an amount associated with the potential transaction; and
determine the data associated with the committed transactions.

10. The apparatus of claim 8, wherein the processor is further configured to:
identify a script associated with the potential transaction, wherein the script comprises one or more of a planned payment amount, a planned payment date, an origination account, a destination account, payment conditions, and a private key verified by contracting parties to the potential transaction.

11. The apparatus of claim 8, wherein the processor is further configured to:
identify the data as one or more planned payments;
identify priorities and debt amounts of the planned payments;
compare the priority and debt amount associated with the potential transaction to the priorities and debt amounts of the planned payments; and
responsive to the comparison, determine whether to commit the potential transaction in the blockchain or reject the potential transaction.

12. The apparatus of claim 11, wherein the processor is further configured to:
retrieve a priority tree data structure from the blockchain; and
identify the planned payments from the priority tree structure.

13. The apparatus of claim 8, wherein the priority associated with the potential transaction comprises a date.

14. The apparatus of claim 8, wherein the processor is further configured to:
identify a planned payment list associated with the data;
verify signatures on all planned payments in the planned payment list;
identify one or more unprocessed planned payments; and
verify a guarantee account is linked to the unprocessed planned payments.

15. A non-transitory computer readable storage medium configured to store instructions that when executed cause a processor to perform:
identifying a potential transaction during a transaction commitment procedure;
retrieving committed transactions associated with an account;
determining a priority associated with the potential transaction;
determining a priority of data associated with the committed transactions;
comparing the priority associated with the potential transaction with the priority of data associated with the committed transactions; and
determining whether to commit the potential transaction in a blockchain or reject the potential transaction.

16. The non-transitory computer readable storage medium of claim 15, wherein the processor is further configured to perform:
determining an amount associated with the potential transaction; and
determining the data associated with the committed transactions.

17. The non-transitory computer readable storage medium of claim 15, wherein the processor is further configured to perform:
identifying a script associated with the potential transaction, wherein the script comprises one or more of a planned payment amount, a planned payment date, an origination account, a destination account, payment conditions, and a private key verified by contracting parties to the potential transaction.

18. The non-transitory computer readable storage medium of claim 15, wherein the processor is further configured to perform:
identifying the data as one or more planned payments;
identifying priorities and debt amounts of the planned payments;
comparing the priority and debt amount associated with the potential transaction to the priorities and debt amounts of the planned payments; and
responsive to the comparing, determining whether to commit the potential transaction in the blockchain or reject the potential transaction.

19. The non-transitory computer readable storage medium of claim 18, wherein the processor is further configured to perform:
retrieving a priority tree data structure from the blockchain; and
identifying the planned payments from the priority tree structure.

20. The non-transitory computer readable storage medium of claim 15, wherein the processor is further configured to perform:
identifying a planned payment list associated with the data;
verifying signatures on all planned payments in the planned payment list;
identifying one or more unprocessed planned payments; and
verifying a guarantee account is linked to the unprocessed planned payments.
